(19) United States
(12) Patent Application Publication
(10) Pub. No.: US 2026/0097729 A1
(43) Pub. Date: Apr. 9, 2026

(54) POWER SUPPLY CONTROL SYSTEM

(71) Applicant: TOYOTA JIDOSHA KABUSHIKI KAISHA, Toyota-shi (JP)

(72) Inventor: Masashi ITO, Toyota-shi (JP)

(73) Assignee: TOYOTA JIDOSHA KABUSHIKI KAISHA, Toyota-shi (JP)

(21) Appl. No.: 19/220,382

(22) Filed: May 28, 2025

(30) Foreign Application Priority Data
Oct. 7, 2024 (JP) 2024-175791

(51) Int. Cl. B60R 16/033; B60L 50/60

(52) U.S. Cl. CPC B60R 16/033; B60L 50/60; B60L 2210/12; B60L 2270/40

(57) ABSTRACT

A power supply control system includes a first relay, a second relay, and a controller. The first relay connects a first in-vehicle battery to an electronic control device to allow electric power to be supplied when program rewriting is not performed. The second relay connects the external power supply to the electronic control device to allow the electric power to be supplied from an external power supply when the program rewriting is performed. The controller is configured to control a connection state of the first relay and the second relay. The controller is configured to, after the external power supply is connected to the second relay controlled to be in a cutoff state, before the program rewriting is started, control the first relay to be in a unidirectional conduction state, and control the second relay to be in the unidirectional conduction state.

### CROSS-REFERENCE TO RELATED APPLICATION

This application claims priority to Japanese Patent Application No. 2024-175791 filed on Oct. 7, 2024. The disclosure of the above-identified application, including the specification, drawings, and claims, is incorporated by reference herein in its entirety.

### BACKGROUND

### 1. Technical Field

The present disclosure relates to a power supply control system that is used when performing program rewriting of an electronic control device by using an external power supply.

### 2. Description of Related Art

Japanese Unexamined Patent Application Publication No. 2007-237905 (JP 2007-237905 A) discloses a system that rewrites a program of an electronic control device mounted on a hybrid vehicle including a main battery and an auxiliary battery. The JP 2007-237905 A describes that when a specific condition is satisfied, a program of the electronic control device supplied with electric power from the auxiliary battery is rewritten with a program transmitted from an external device outside the vehicle.

### SUMMARY

In a case where the electric power capacity of the auxiliary battery is insufficient to perform program rewriting of the electronic control device, performing the program rewriting of the electronic control device by using a power supply (such as a power supply equipment or a charger) outside the vehicle is conceivable. However, in this case, when the external power supply is connected to the vehicle without considering an electrical connection state of the auxiliary battery, overcharging or overcurrent of the auxiliary battery due to the external power supply may occur (in a case where the voltage of the external power supply is greater than the voltage of the auxiliary battery). In addition, the current may flow from the auxiliary battery to the external power supply, resulting in the electric power of the auxiliary battery being wastefully consumed (in a case where the voltage of the external power supply is smaller than the voltage of the auxiliary battery).

Therefore, when performing the program rewriting of the electronic control device by using the external power supply, power supply control needs to be considered.

The present disclosure has been made in view of the above problems, and an object of the present disclosure is to provide a power supply control system that can suitably perform program rewriting of an electronic control device by using an external power supply.

In order to solve the above problems, an aspect of a technique of the present disclosure relates to a power supply control system that is used when performing program rewriting of an electronic control device by using an external power supply, the power supply control system including: a first relay configured to connect a first in-vehicle battery to the electronic control device to allow electric power to be supplied when the program rewriting is not performed; a second relay configured to connect the external power supply to the electronic control device to allow electric power to be supplied when the program rewriting is performed; and a controller configured to control a connection state of the first relay and the second relay, in which the controller is configured to, after the external power supply is connected to the second relay controlled to be in a cutoff state and before the program rewriting is started, control the first relay to be in a unidirectional conduction state in which a current direction is restricted to a direction from the first in-vehicle battery to the electronic control device, control the second relay to be in a unidirectional conduction state in which a current direction is restricted to a direction from the external power supply to the electronic control device, control the first relay to be in a cutoff state, and control the second relay to be in a bidirectional conduction state in which a current direction is not restricted.

With the power supply control system according to the present disclosure, since the first in-vehicle battery (auxiliary battery) and the external power supply are not electrically connected to each other, it is possible to suitably perform program rewriting of the electronic control device even when the external power supply is used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a power supply control system and peripheral units thereof according to an embodiment of the present disclosure;

FIG. 2A is a diagram illustrating a relay configured by a field effect transistor;

FIG. 2B is a diagram illustrating a relay configured by a field effect transistor;

FIG. 2C is a diagram illustrating a relay configured by a field effect transistor;

FIG. 2D is a diagram illustrating a relay configured by a field effect transistor;

FIG. 3 is a processing flowchart illustrating pre-reprogramming control executed by the power supply control system before performing program rewriting of the electronic control device;

FIG. 4 is a processing flowchart illustrating post-reprogramming control executed by the power supply control system after performing program rewriting of the electronic control device;

FIG. 5A is a diagram illustrating a connection state of a power supply control system in pre-reprogramming control;

FIG. 5B is a diagram illustrating a connection state of the power supply control system in the pre-reprogramming control;

FIG. 5C is a diagram illustrating a connection state of the power supply control system in the pre-reprogramming control;

FIG. 5D is a diagram illustrating a connection state of the power supply control system in the pre-reprogramming control;

FIG. 5E is a diagram illustrating a connection state of the power supply control system in the pre-reprogramming control;

FIG. 5F is a diagram illustrating a connection state of the power supply control system in the pre-reprogramming control;

FIG. 6A is a diagram illustrating a connection state of a power supply control system in post-reprogramming control;

FIG. 6B is a diagram illustrating a connection state of a power supply control system in the post-reprogramming control;

FIG. 6C is a diagram illustrating a connection state of a power supply control system in the post-reprogramming control;

FIG. 6D is a diagram illustrating a connection state of a power supply control system in the post-reprogramming control;

FIG. 6E is a diagram illustrating a connection state of the power supply control system in the post-reprogramming control; and

FIG. 6F is a diagram illustrating a connection state of the power supply control system in the post-reprogramming control.

### DETAILED DESCRIPTION OF EMBODIMENTS

In the power supply control system according to the present disclosure, in a case where the external power supply is used to rewrite the program of the electronic control device, the transition control is executed such that the auxiliary battery and the external power supply are not in an electrical conduction state in a process of switching the power source of the electronic control device from the auxiliary battery to the external power supply. With the control, the occurrence of the unfavorable overcharging or the electric power of the auxiliary battery being wastefully consumed can be avoided.

Hereinafter, an embodiment of the present disclosure will be described in detail with reference to the drawings.

### Embodiment

### Configuration

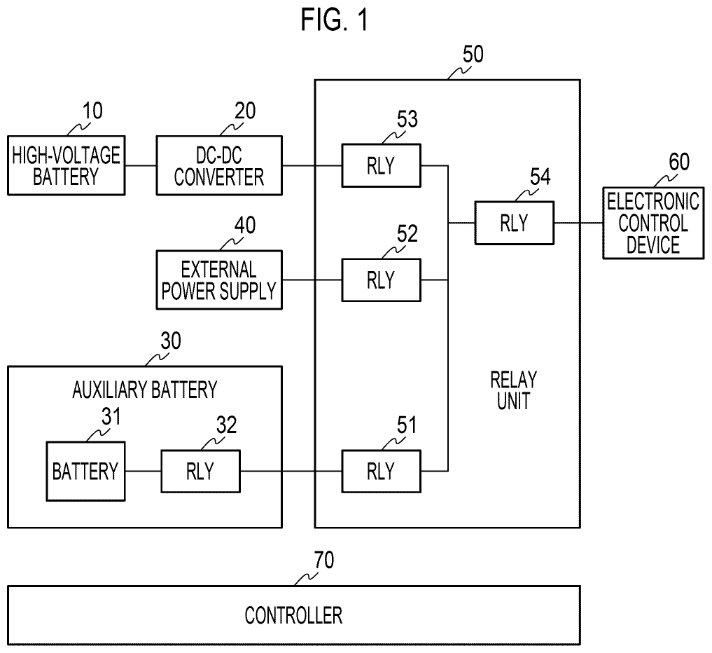

FIG. 1 is a functional block diagram of a power supply control system and peripheral units thereof according to the embodiment of the present disclosure. The functional block illustrated in FIG. 1 includes a high-voltage battery 10, a DC-DC converter 20, an auxiliary battery 30, an external power supply 40, a relay unit 50, an electronic control device 60, and a controller 70.

The configuration illustrated in FIG. 1 can be mounted on an electrified vehicle, such as a hybrid electric vehicle (HEV), a plug-in hybrid electric vehicle (PHEV), and a battery electric vehicle (BEV), as an example.

The high-voltage battery 10 is a secondary battery configured to be charged and discharged, such as a lithium ion battery (first in-vehicle battery). The high-voltage battery 10 can supply the electric power stored in the high-voltage battery 10 to the electronic control device 60 (and the auxiliary battery 30) via the DC-DC converter 20 and the relay unit 50. In the electrified vehicle, for example, a drive battery corresponds to the high-voltage battery 10.

The DC-DC converter 20 is a voltage converter provided between the high-voltage battery 10 and the relay unit 50. The DC-DC converter 20 converts the voltage of the high-voltage battery 10 input thereto into a voltage needed for the electronic control device 60 (and the auxiliary battery 30), and outputs the voltage to the electronic control device 60 (and the auxiliary battery 30) via the relay unit 50. The DC-DC converter 20 can use, for example, a buck-type DC-DC converter that steps down an input voltage and outputs the stepped-down voltage.

The auxiliary battery 30 is a secondary battery configured to be charged and discharged, such as a lithium ion battery (second in-vehicle battery). The auxiliary battery 30 can supply the electric power stored in the auxiliary battery 30 to the electronic control device 60 through the relay unit 50. The auxiliary battery 30 can store the electric power output from the high-voltage battery 10 via the DC-DC converter 20 and the relay unit 50. The auxiliary battery 30 includes a battery 31 that stores electric power and a relay (RLY) 32 that can switch an electrical connection state between the battery 31 and the relay unit 50. A circuit configuration to be described later is used for the relay 32.

The external power supply 40 is a power supply that can be connected to an external power supply connection terminal (or a rescue terminal) provided in the vehicle in advance to supply electric power. Examples of the external power supply 40 include power supply equipment, such as a charging stand, and a portable charger.

The relay unit 50 is a configuration for connecting the DC-DC converter 20, the auxiliary battery 30, and the external power supply 40 in parallel to output electric power of each component to the electronic control device 60. The relay unit 50 includes at least a relay (RLY) 51 connected to the auxiliary battery 30 at one end, a relay (RLY) 52 connected to the external power supply 40 at one end, a relay (RLY) 53 connected to the DC-DC converter 20 at one end, and a relay (RLY) 54 connected to the electronic control device 60 at one end. The other ends of the relays 51 to 54 are connected to each other. When a plurality of electronic control devices 60 is provided, a relay may be provided for connection to each electronic control device 60. At least the relay 52 among the relays 51 to 54 is used for a circuit configuration to be described later.

The electronic control device 60 is an in-vehicle device (auxiliary load) that operates with the electric power supplied from the high-voltage battery 10 through the DC-DC converter 20 or the electric power supplied from the auxiliary battery 30. The number of electronic control devices 60 mounted on the vehicle is not limited to the number illustrated in FIG. 1.

The controller 70 is configured to control an electrical connection state between the high-voltage battery 10, the auxiliary battery 30, the external power supply 40, and the electronic control device 60 when rewriting the program of the electronic control device 60 is performed by using the external power supply 40. The controller 70 at least controls the DC-DC converter 20, the relay 32 of the auxiliary battery 30, and the relay 52 of the relay unit 50. The control executed by the controller 70 instructing the DC-DC converter 20, the relay 32, and the relay 52 will be described below.

### Relay Circuit

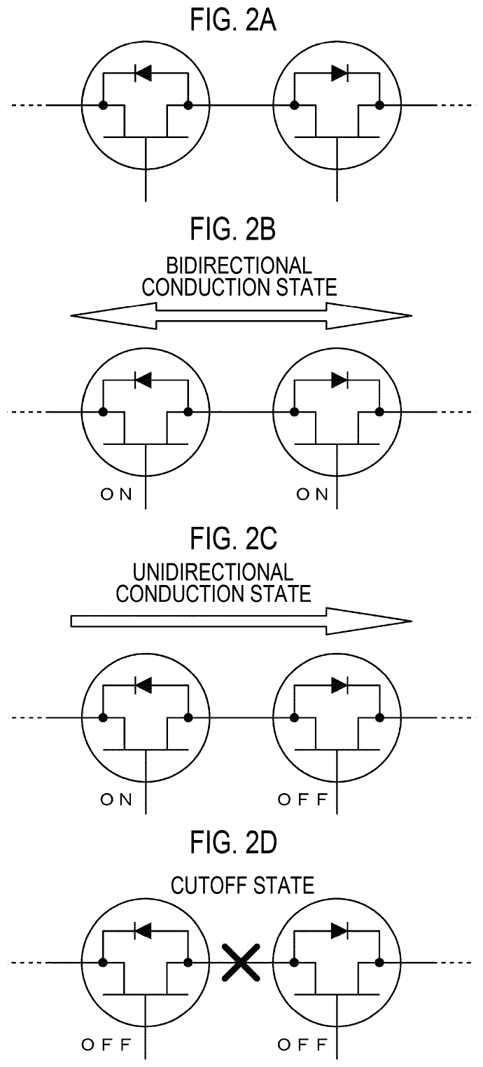

As illustrated in FIG. 2A, circuits having a configuration in which two field effect transistors (FETs) are connected in series with the rectification direction of a body diode reversed are used for the relay 32 of the auxiliary battery 30 and the relay 52 of the relay unit 50.

In the configuration, in a case where both of the field effect transistors are in the on state (gate voltage: ON), the current can flow in both directions, and thus a “bidirectional conduction state” is set (FIG. 2B). In addition, in the configuration, when both of the field effect transistors are in the off state (gate voltage: OFF), the current cannot flow in any direction, and a “cutoff state” is set (FIG. 2D). In addition, in the configuration, in a case where one of the field effect transistors is in an on state (gate voltage: ON) and the other of the field effect transistors is in an off state (gate voltage: OFF), a “unidirectional conduction state (DiOR)” in which the current can flow in one direction from the transistor on the ON side to the transistor on the OFF side is set (FIG. 2C).

### Control

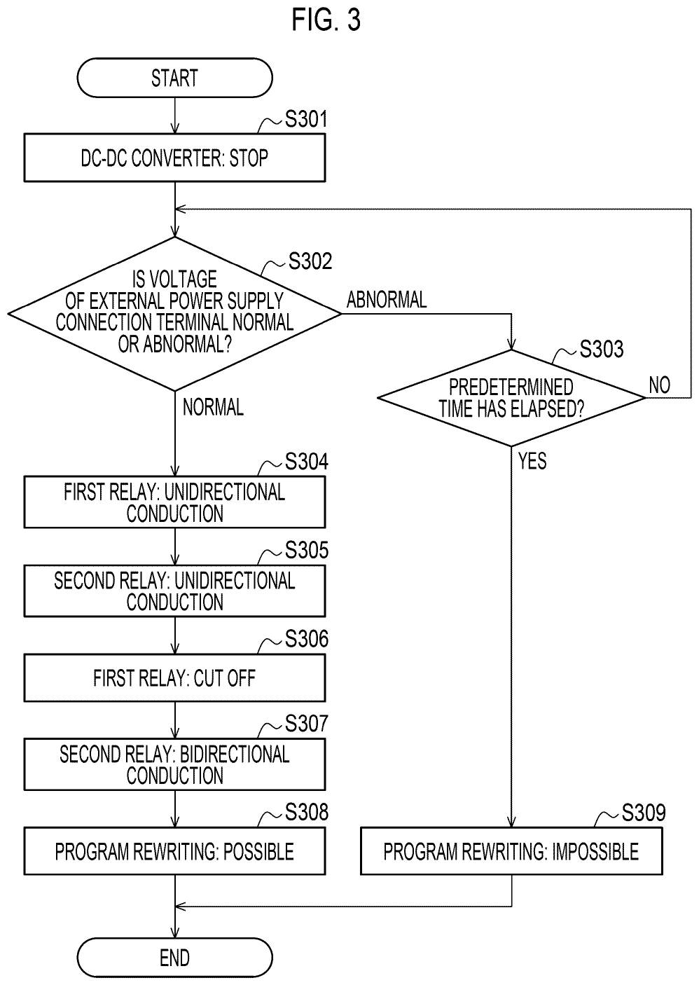

Next, the control executed in the power supply control system according to the present embodiment will be described with further reference to FIGS. 3 to 6D to 6F.

### (1) Control Before Program Rewriting

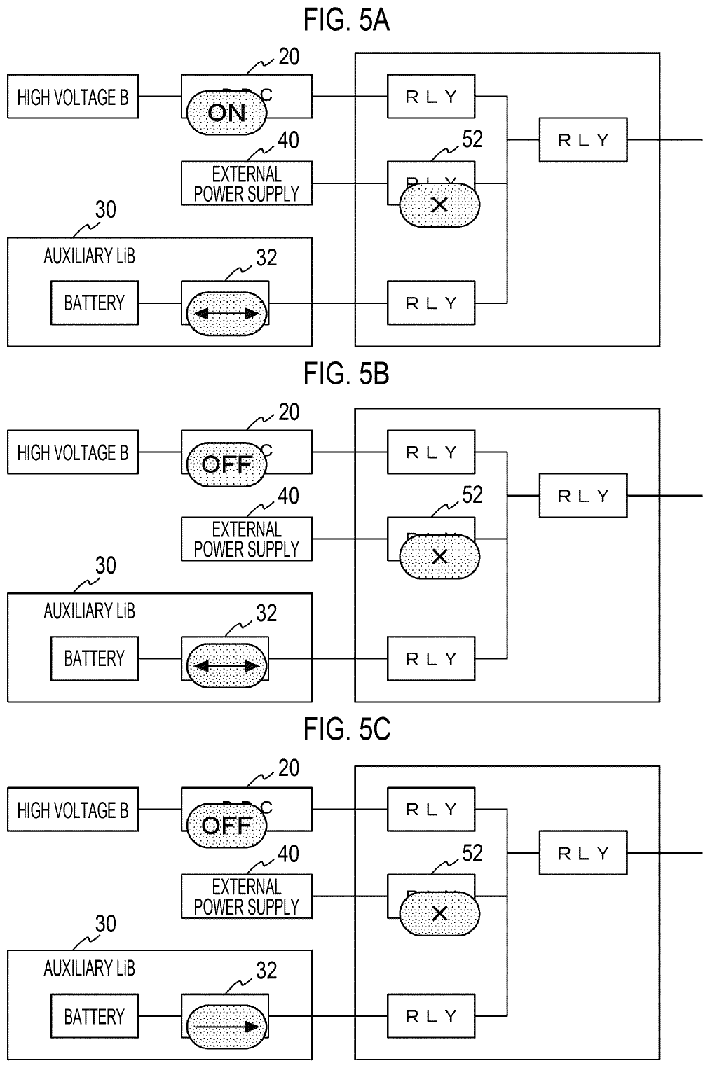

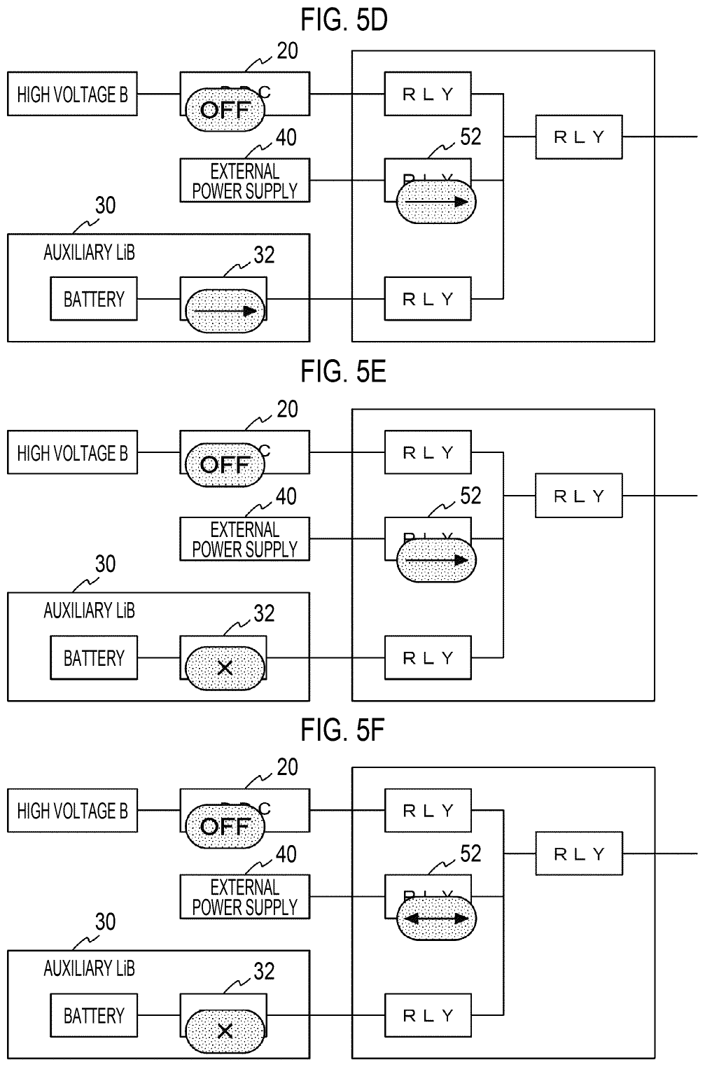

FIG. 3 is a flowchart illustrating a processing procedure of pre-reprogramming control that is control executed by the controller 70 of the power supply control system before performing program rewriting of the electronic control device 60. FIGS. 5A to 5F are diagrams for describing a connection state of the power supply control system over time in the pre-reprogramming control.

The pre-reprogramming control illustrated in FIG. 3 is started by receiving a request or instruction to perform program rewriting of the electronic control device 60 from a predetermined configuration. The state of each configuration at the time of starting the pre-reprogramming control is a normal state in which the vehicle is Power_ON. In addition, the DC-DC converter 20 is in an operating state (ON). Further, a relay 32 (hereinafter referred to as “first relay 32”) of the auxiliary battery (auxiliary LiB) 30 is in a bidirectional conduction state, and a relay 52 (hereinafter referred to as “second relay 52”) of the relay unit 50 is in a cutoff state (state of FIG. 5A). In addition, it is assumed that the relays 51, 53, 54 of the relay unit 50 are always in a bidirectional conduction state in the pre-reprogramming control.

### S301

The controller 70 stops the operation of the DC-DC converter 20. As a result, the high-voltage battery 10 is electrically disconnected from the relay unit 50 (state of FIG. 5B). When the DC-DC converter 20 is stopped, the process proceeds to S302.

### S302

The controller 70 determines whether the voltage of the external power supply connection terminal of the vehicle is normal or abnormal. The determination is made to determine whether the external power supply 40 is correctly connected to the external power supply connection terminal, and also to determine whether the external power supply 40 having the correct voltage is connected to the terminal, in addition to the fact that the external power supply 40 is physically connected to the terminal. Therefore, an error such as overvoltage application or reverse connection of plus and minus can be eliminated. The determination can be made using a voltage sensor or the like provided in advance in the external power supply connection terminal. When the controller 70 determines that the voltage of the external power supply connection terminal is normal (S302, normal), the process proceeds to S304. On the other hand, in a case where the controller 70 determines that the voltage of the external power supply connection terminal is abnormal (S302, abnormal), the process returns to S303.

### S303

The controller 70 determines whether a predetermined time has elapsed after the stop of the DC-DC converter 20. The determination is made for the purpose of providing a temporal margin for the determination in S302 since the connection of the external power supply 40 to the external power supply connection terminal is a manual operation. At a predetermined time, any time that is sufficient for determination is set. When the controller 70 determines that the predetermined time has elapsed (S303, Yes), the process proceeds to S309. On the other hand, when the controller 70 determines that the predetermined time has not elapsed (S303, No), the process proceeds to S302.

### S304

The controller 70 controls the first relay 32 to be in a unidirectional conduction state. As a result, the first relay 32 is in a state in which the current flows from the auxiliary battery 30 to the relay unit 50 (state of FIG. 5C). When the first relay 32 is controlled to be in the unidirectional conduction state, the process proceeds to S305.

### S305

The controller 70 controls the second relay 52 to be in a unidirectional conduction state. As a result, the second relay 52 is in a state in which the current flows from the external power supply 40 toward the relay unit 50 (state of FIG. 5D). When the second relay 52 is controlled to be in the unidirectional conduction state, the process proceeds to S306.

### S306

The controller 70 controls the first relay 32 to be in the cutoff state. As a result, the auxiliary battery 30 is electrically disconnected from the relay unit 50 (state of FIG. 5E). When the first relay 32 is controlled to be in the cutoff state, the process proceeds to S307.

### S307

The controller 70 controls the second relay 52 to be in the bidirectional conduction state. As a result, the second relay 52 is in a state in which the current flows from the external power supply 40 and the relay unit 50 (state of FIG. 5F). When the second relay 52 is controlled to be in the bidirectional conduction state, the process proceeds to S308.

### S308

The controller 70 determines that the program rewriting of the electronic control device 60 can be performed, and ends the pre-reprogramming control. In response to the possibility determination, a rewriting process of the program of the electronic control device 60 by the predetermined device is performed.

As the process of rewriting the program of the electronic control device 60, a wired reprogramming process of connecting a cable to the vehicle and performing the process by wire, or a wireless reprogramming process of connecting the vehicle to the Internet or the like and performing the process by wireless (On The Air (OTA)) can be exemplified.

### S309

The controller 70 determines that the program rewriting of the electronic control device 60 cannot be performed, and ends the pre-reprogramming control. In response to the impossibility determination, a predetermined process (stop, wait, re-try, or the like) is performed on the rewriting process of the program of the electronic control device 60 by the predetermined device.

### (2) Control After Program Rewriting

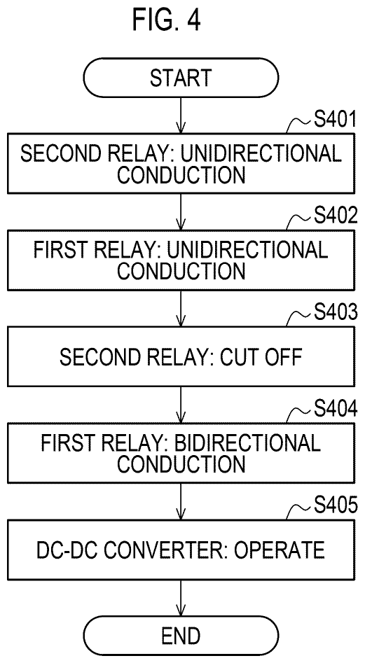

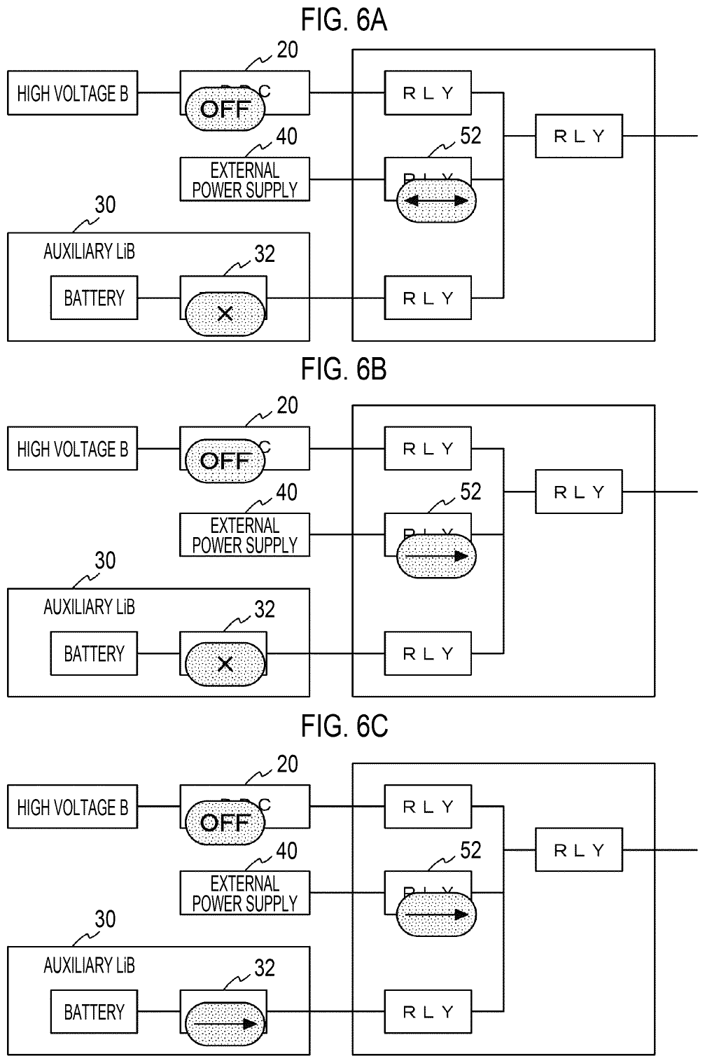

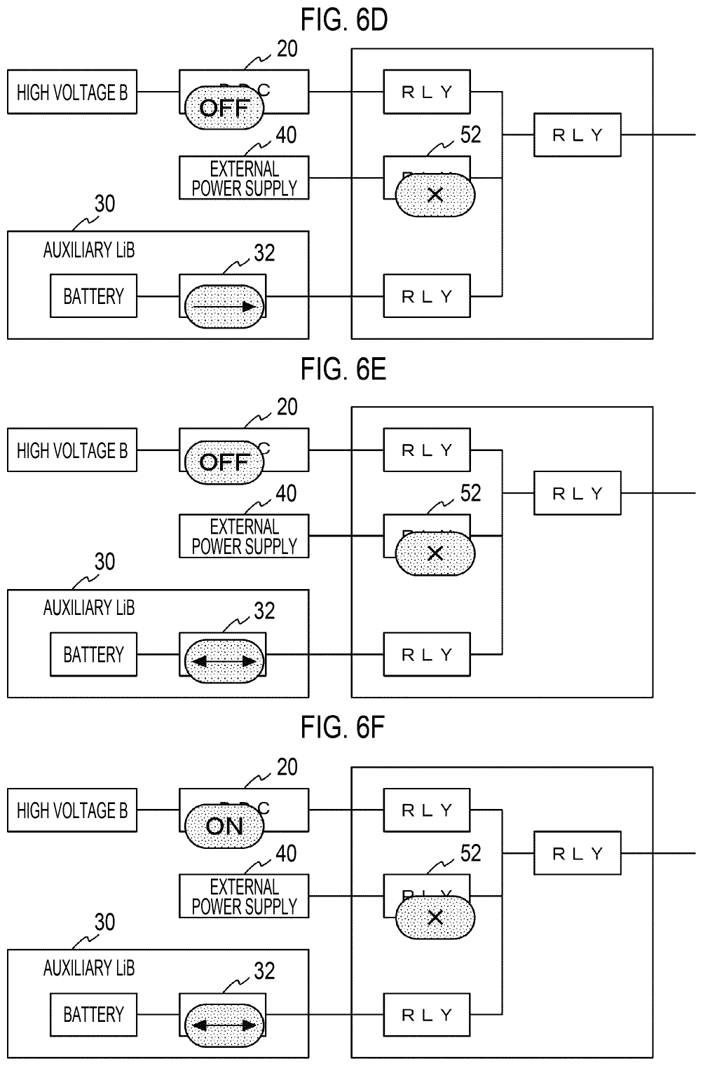

FIG. 4 is a flowchart illustrating a processing procedure of post-reprogramming control that is control executed by the controller 70 of the power supply control system after performing program rewriting of the electronic control device 60. FIGS. 6A to 6F are diagrams for describing a connection state of the power supply control system over time in the post-reprogramming control.

The post-reprogramming control illustrated in FIG. 4 is started after the rewriting process of the program of the electronic control device 60 by the predetermined device is performed. When the post-reprogramming control is started, the state of each configuration is that the DC-DC converter 20 is in a stop state (OFF), and the first relay 32 of the auxiliary battery (auxiliary LiB) 30 is in a cutoff state. Further, the second relay 52 of the relay unit 50 is in a bidirectional conduction state (state of FIG. 6A). In addition, it is assumed that the relays 51, 53, 54 of the relay unit 50 are always in a bidirectional conduction state in the pre-reprogramming control.

### S401

The controller 70 controls the second relay 52 to be in a unidirectional conduction state. As a result, the second relay 52 is in a state in which the current flows from the external power supply 40 toward the relay unit 50 (state of FIG. 6B). When the second relay 52 is controlled to be in the unidirectional conduction state, the process proceeds to S402.

### S402

The controller 70 controls the first relay 32 to be in a unidirectional conduction state. As a result, the first relay 32 is in a state in which the current flows from the auxiliary battery 30 to the relay unit 50 (state of FIG. 6C). When the first relay 32 is controlled to be in the unidirectional conduction state, the process proceeds to S403.

### S403

The controller 70 controls the second relay 52 to be in the cutoff state. As a result, the external power supply 40 is electrically disconnected from the relay unit 50 (state of FIG. 6D). When the second relay 52 is controlled to be in the cutoff state, the process proceeds to S404.

### S404

The controller 70 controls the first relay 32 to be in the bidirectional conduction state. As a result, the first relay 32 is in a state where the current flows from the auxiliary battery 30 and the relay unit 50 (state of FIG. 6E). When the first relay 32 is controlled to be in the bidirectional conduction state, the process proceeds to S405.

### S405

The controller 70 causes the stopped DC-DC converter 20 to operate. As a result, the high-voltage battery 10 is electrically connected to the relay unit 50, and the electric power can be supplied to the electronic control device 60 together with the auxiliary battery 30 (state of FIG. 6F). As a result, the vehicle returns to the normal state in which the vehicle is powered on. When the DC-DC converter 20 operates, the post-reprogramming control is terminated.

### Action and Effect

As described above, with the power supply control system according to the embodiment of the present disclosure, the first relay 32 on the auxiliary battery 30 side is controlled to the unidirectional conduction state before the second relay 52 on the external power supply 40 side is controlled to the unidirectional conduction state, before the process of rewriting the program of the electronic control device 60 by using the external power supply 40 is performed. Thereafter, the first relay 32 is controlled to the cutoff state, and then the second relay 52 is controlled to the bidirectional conduction state.

With the relay switching control, the auxiliary battery 30 and the external power supply 40 are not electrically connected to each other, and thus overcharging and electric power of the auxiliary battery 30 being wastefully consumed can be avoided.

In addition, with the power supply control system according to the embodiment of the present disclosure, the first relay 32 on the auxiliary battery 30 side and the second relay 52 on the external power supply 40 side are not switched at the same time, and thus the possibility that the power supply of the vehicle is lost (momentarily interrupted) is also eliminated.

Although the embodiment of the present disclosure has been described above, the present disclosure can be regarded as a method performed by a power supply control system including a processor and a memory, a program of the method, a computer-readable non-transitory recording medium storing the program, a vehicle equipped with the power supply control system, or the like, in addition to the power supply control system described above.

The power supply control system of the present disclosure can be used in a vehicle or the like that performs program rewriting of an in-vehicle device by using an external power supply.

What is claimed is:

1. A power supply control system that is used when performing program rewriting of an electronic control device by using an external power supply, the power supply control system comprising:
a first relay configured to connect a first in-vehicle battery to the electronic control device to allow electric power to be supplied when the program rewriting is not performed;
a second relay configured to connect the external power supply to the electronic control device to allow electric power to be supplied when the program rewriting is performed; and
a controller configured to control a connection state of the first relay and the second relay,
wherein the controller is configured to, after the external power supply is connected to the second relay controlled to be in a cutoff state and before the program rewriting is started,
control the first relay to be in a unidirectional conduction state in which a current direction is restricted to a direction from the first in-vehicle battery to the electronic control device,
control the second relay to be in a unidirectional conduction state in which a current direction is restricted to a direction from the external power supply to the electronic control device,
control the first relay to be in a cutoff state, and
control the second relay to be in a bidirectional conduction state in which a current direction is not restricted.

2. The power supply control system according to claim 1, wherein the controller is configured to, after the program rewriting is completed and before the external power supply is disconnected from the second relay,
control the second relay to be in the unidirectional conduction state in which the current direction is restricted to the direction from the external power supply to the electronic control device,
control the first relay to be in the unidirectional conduction state in which the current direction is restricted to the direction from the first in-vehicle battery to the electronic control device,
control the second relay to be in the cutoff state, and
control the first relay to be in a bidirectional conduction state in which a current direction is not restricted.

3. The power supply control system according to claim 1, wherein the controller is configured to, in a case where the electronic control device receives the electric power supplied from a second in-vehicle battery via a DC-DC converter when the program rewriting is not performed, stop the DC-DC converter before the program rewriting is started and before the first relay is controlled to be in the unidirectional conduction state.

4. The power supply control system according to claim 2, wherein the controller is configured to, in a case where the electronic control device receives the electric power supplied from a second in-vehicle battery via a DC-DC converter when the program rewriting is not performed, operate the DC-DC converter after the program rewriting is completed and after the first relay is controlled to be in the bidirectional conduction state.

5. The power supply control system according to claim 1, wherein each of the first relay and the second relay has a configuration in which two field effect transistors are connected in series with rectification directions of body diodes of the two field effect transistors being opposite to each other.
